(19) United States
(12) Patent Application Publication
(10) Pub. No.: US 2007/0293133 A1
(43) Pub. Date: Dec. 20, 2007

(54) DISPOSABLE HOOD BAFFLE FOR COMMERCIAL KITCHEN

(76) Inventor: Kenneth Marcotte, Edison, NJ (US)

Correspondence Address: WALTER J. TENCZA JR., 100 Menlo Park, Suite 210, Edison, NJ, 08837, US

(21) Appl. No.: 11/309,085

(22) Filed: Jun. 19, 2006

(51) Int. Cl. B08B 15/02

(52) U.S. Cl. 454/67

(57) ABSTRACT

An apparatus is provided for collecting grease from a cooking device, such as an oven. The apparatus may include a baffle or device comprising a first set of a plurality of rails oriented in a first direction and a second set of a plurality of rails oriented in a second direction which is opposite to the first direction. The baffle may be made of lightweight aluminum. Each of the first set of a plurality of rails overlaps one of each of the second set of a plurality of rails. Each of the rails of the first set and the second set of a plurality of rails may be connected to a housing. The apparatus may further include an attachment device for attaching the baffle to a hood device, so that smoke sucked in by a fan in the hood device can pass through the baffle and into the hood device while the baffle remains stationary.

### FIELD OF THE INVENTION

This invention relates to baffles for commercial kitchens.

### BACKGROUND OF THE INVENTION

Heavy gauge hood baffles are used in commercial kitchens above oven top areas to trap grease and smoke, which is sucked in by an overhead fan, from cooking operations. These heavy gauge hood baffles trap grease in hard to clean areas. This creates unsanitary conditions and a fire hazard. Existing heavy gauge hood baffles are labor intensive to clean and change.

### SUMMARY OF THE INVENTION

In one embodiment, an apparatus is provided for collecting grease from a cooking device, such as an oven. The apparatus may include a baffle or device comprising a first set of a plurality of rails oriented in a first direction and a second set of a plurality of rails oriented in a second direction which is opposite to the first direction. Each of the first set of a plurality of rails overlaps one of each of the second set of a plurality of rails. Each of the rails of the first set and the second set of a plurality of rails may be connected to a housing.

The apparatus may further include an attachment device for attaching the baffle to a hood device, so that smoke sucked in by a fan in the hood device can pass through the baffle and into the hood device while the baffle remains stationary The baffle may be comprised of a light weight metal material or light weight plastic. The baffle may be comprised of aluminum. The attachment device may be comprised of a plurality of hooks which attaches the housing to the hood device.

The present invention, also provides a method comprising placing a baffle, comprised of a housing, in a hood device, and attaching the baffle to the hood device, so that smoke sucked in by a fan in the hood device can pass through the baffle and into the hood device while the baffle remains stationary.

### BRIEF DESCRIPTION OF THE DRAWINGS

FIG. 1 shows a top view a baffle or device in accordance with an embodiment of the present invention, with part of the baffle shown in dashed lines;

FIG. 2 shows a top view part of the baffle or device of FIG. 1;

FIG. 3 shows a bottom view of the baffle or device of FIG. 1, with part of the baffle shown in dashed lines;

FIG. 4 shows a bottom view of part of the baffle or device of FIG. 1;

FIG. 5 shows a rear view of the baffle or device of FIG. 1;

FIG. 6 shows a right side view of the baffle or device of FIG. 1;

FIG. 7 shows an isometric perspective view of the baffle or device of FIG. 1, with part of the baffle shown in dashed lines;

FIG. 8 shows an isometric perspective view of part of the baffle or device of FIG. 1;

FIG. 9 shows a cross section view of two of rails or members of the baffle of FIG. 1;

FIG. 10 shows a perspective view of the baffle of FIG. 1, positioned within an overhead hood shown in dashed lines.

### DETAILED DESCRIPTION OF THE DRAWINGS

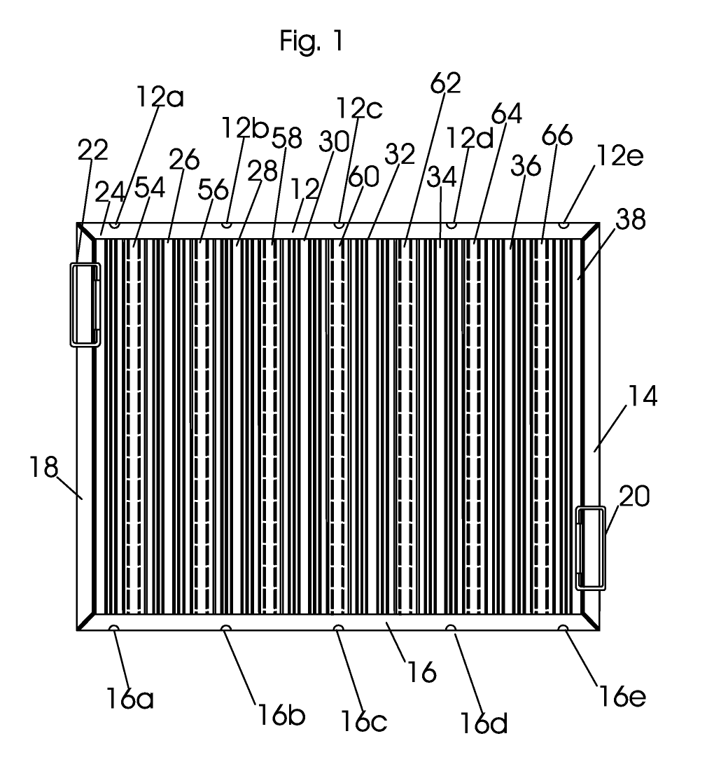

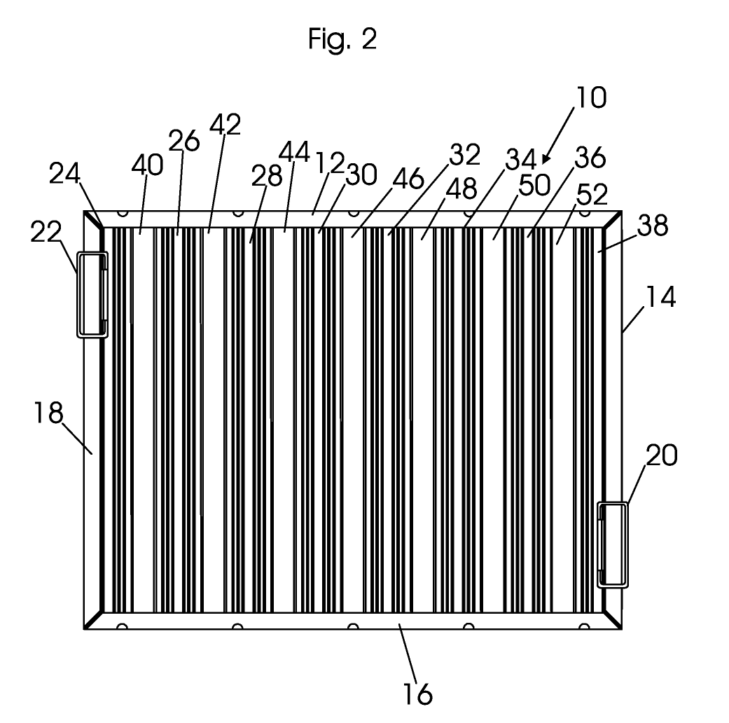

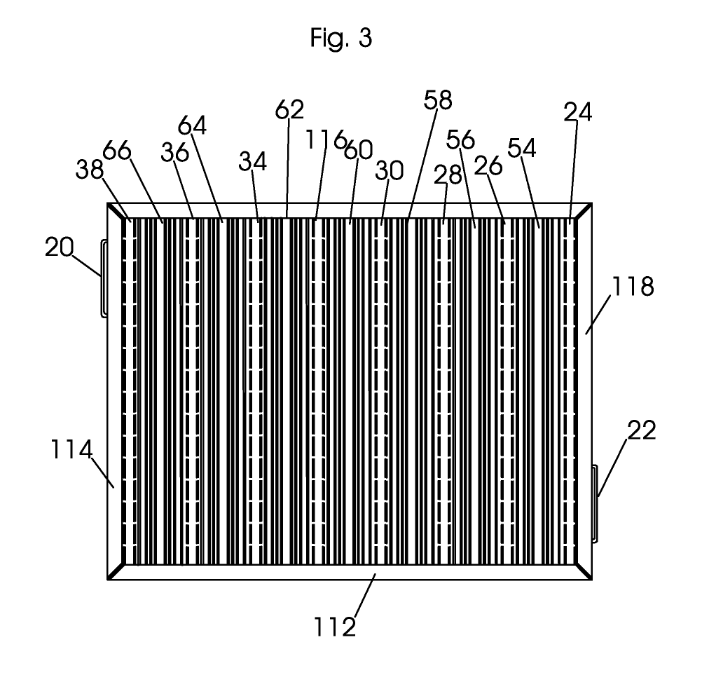

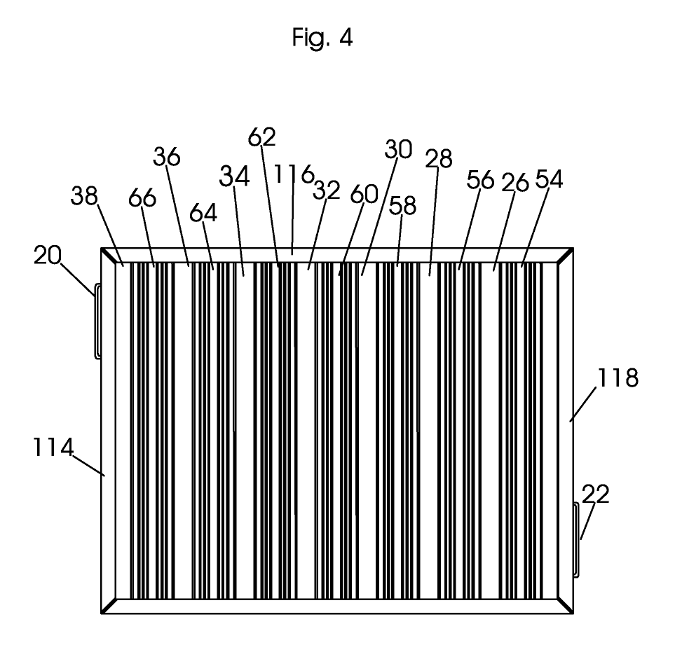

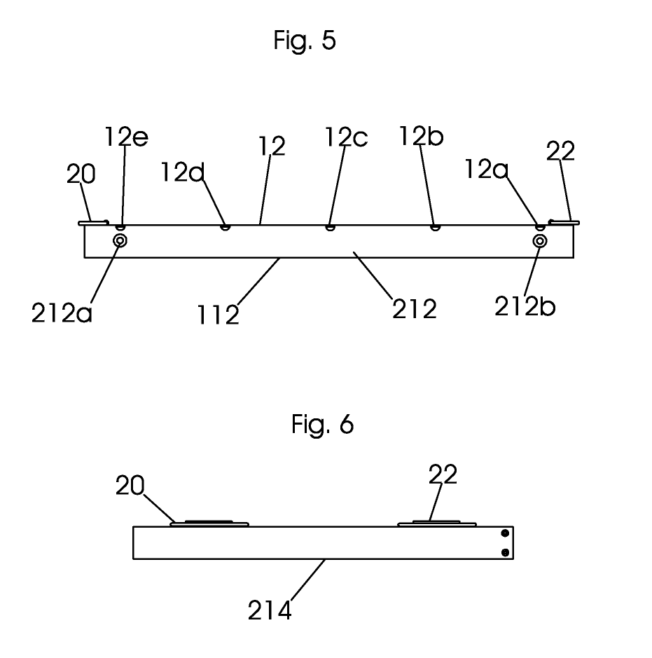

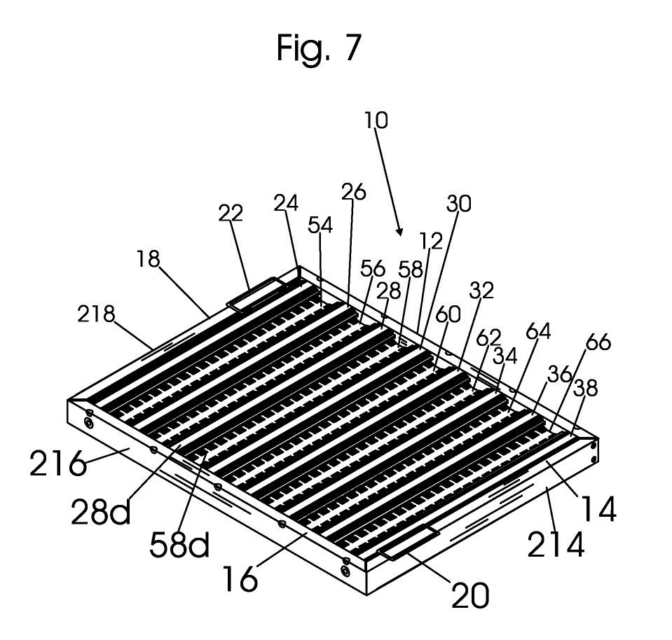

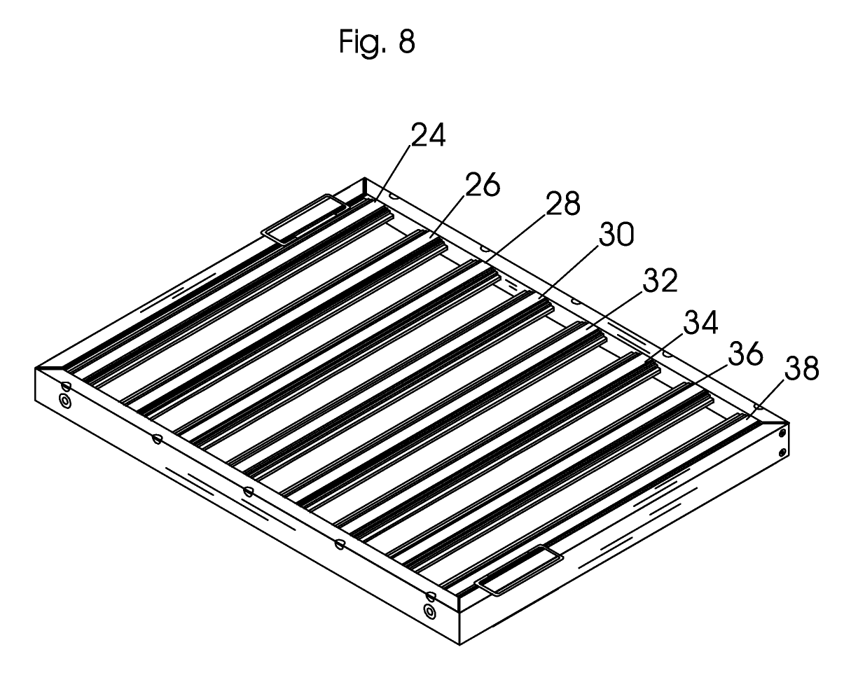

FIG. 1 shows a top view a baffle or device 10 for use in accordance with an embodiment of the present invention, with part of the baffle 10 shown in dashed lines. FIG. 2 shows a top view part of the baffle or device 10. FIG. 3 shows a bottom view of the baffle or device 10, with part of the baffle shown in dashed lines. FIG. 4 shows a bottom view of part of the baffle or device 10. FIG. 5 shows a rear view of the baffle or device 10. FIG. 6 shows a right side view of the baffle or device 10. FIG. 7 shows an isometric perspective view of the baffle or device 10, with part of the baffle 10 shown in dashed lines. FIG. 8 shows an isometric perspective view of part of the baffle or device 10.

The baffle or device 10 may be have a structure as known in the art, with the exceptions that the baffle 10 is made of a lightweight material, such as lightweight aluminum, or of lightweight plastic. In the prior art, baffles used in over head hoods in cooking operations are typically made of a heavy guage metal, such as steel or a heavy guage aluminum to prevent the baffle from being sucked into an over head fan.

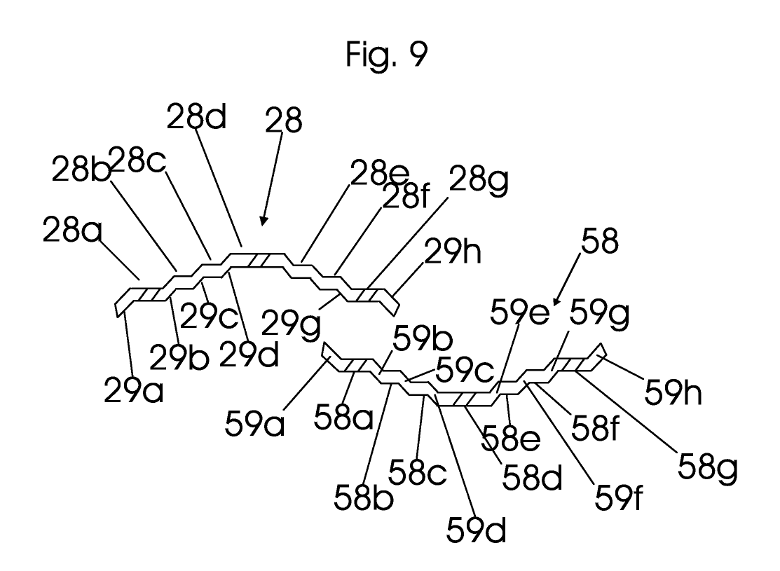

The baffle or device 10 may include members or plates 12, 14, 16, and 18 and loop handles 20 and 22, as shown in FIGS. 1 and 2. The handles 20 and 22 may be eliminated. The member 12 may have semicircular openings 12a, 12b, 12c, 12d, and 12e. The member 16 may have semicircular openings 16a, 16b, 16c, 16d, and 16e. The baffle or device 10 may include members or rails 24, 26, 28, 30, 32, 34, 36, and 38 shown in FIGS. 1 and 7. The members or rails 24, 26, 28, 30, 32, 34, 36, and 38 may be identical to each other. As shown in FIG. 2, there are spaces or gaps between the rails. Gap 40 lies between rail 24 and 26, gap 42 lies between rail 26 and 28, gap 44 lies between rail 28 and 30, gap 46 lies between rail 30 and 32, gap 48 lies between rail 32 and 34, gap 50 lies between rail 34 and 36, and gap 52 lies between rail 36 and 38. A cross section for member or rail 28, is shown in FIG. 9. Member or rail 28 includes horizontal members 28a, 28b, 28c, 28d, 28e, 28f, and 28g and members 29a, 29b, 29c, 29d, 29e, 29f, 29g, and 29h.

The baffle or device 10 may also include members or rails 54, 56, 58, 60, 62, 64, and 66, shown in dashed lines in FIGS. 1 and 7. The members or rails 54, 56, 58, 60, 62, 64, and 66 may be identical to each other. A cross section for member or rail 58 is also shown in FIG. 9. Member or rail 58 includes horizontal members 58a, 58b, 58c, 58d, 58e, 58f, and 58g and members 59a, 59b, 59c, 59d, 59e, 59f, 59g, and 59h. The member or rails 54, 56, 58, 60, 62, 64, and 66 are inverted with respect to the members or rails 24, 26, 28, 30, 32, 34, 36, and 38 but are otherwise identical.

The baffle or device 10 may include members or plates 112, 114, 116, and 118 shown in FIG. 3. The members or plates 112, 114, 116, and 118, shown in FIG. 3, are parallel to the plates 12, 14, 16, and 18, respectfully, shown in FIG. 1. The members or plates 112, 114, 116, and 118 are substantially perpendicular to and connected to members or plates 212, 214, 216, and 218, respectfully, whose location is shown in FIG. 7.

The combination of members 12, 14, 16, 18, 112, 114, 116, 118, and 212, 214, 216, and 218 may be considered to be a housing.

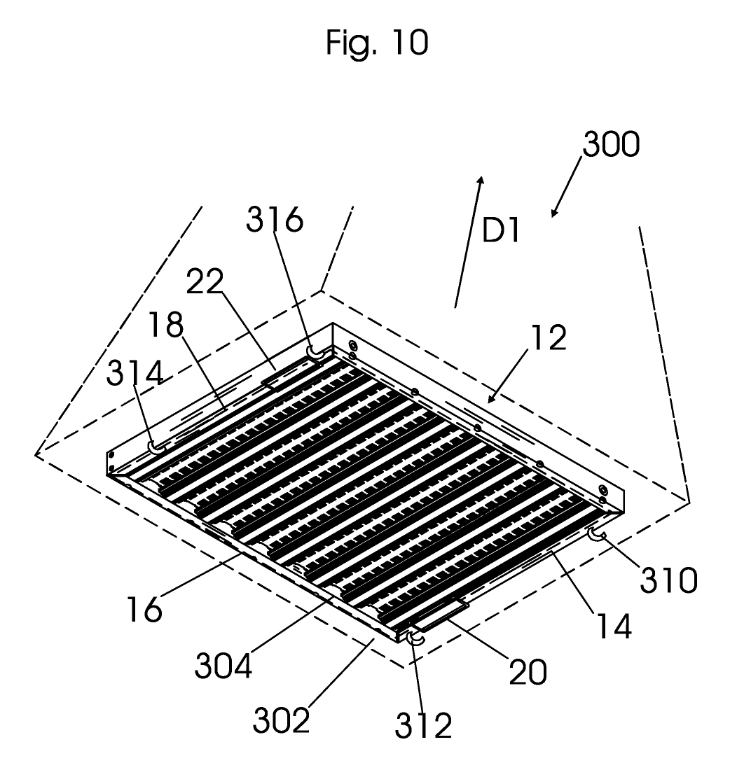

FIG. 10 shows a perspective view of the baffle 10 of FIG. 1, positioned within an overhead hood device 300 shown in dashed lines. The overhead hood 300 may include an fan, such as an exhaust fan, which sucks grease, smoke, and air in the direction D1 through baffle 10. In accordance with an embodiment of the present invention, the baffle 10 is hooked by hooks 310, 312, 314, and 316 to an underside 302 of the overhead hood device 300. The overhead hood device 300 has an opening 304 through which grease, smoke, and air is sucked in, in the direction D1. In contrast to the present invention, baffles of the prior art were not hooked to an underside of a hood device, but rather were just laid down on an angle on the underside. The weight of the prior art baffles was used to prevent the heavy baffles from being sucked upwards into a hood device.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus for collecting grease from a cooking device comprising:
a baffle comprising
a first set of a plurality of rails oriented in a first direction;
a second set of a plurality of rails oriented in a second direction which is opposite to the first direction;
wherein each of the first set of a plurality of rails overlaps one of each of the second set of a plurality of rails;
wherein each of the rails of the first set and the second set of a plurality of rails is connected to a housing;
and further comprising an attachment device for attaching the baffle to a hood device, so that smoke sucked in by a fan in the hood device can pass through the baffle and into the hood device while the baffle remains stationary.

2. The apparatus of claim 1
wherein the baffle is comprised of a lightweight metal material.

3. The apparatus of claim 1
wherein the baffle is comprised of aluminum.

4. The apparatus of claim 1
wherein the baffle is comprised of plastic.

5. The apparatus of claim 1
wherein the attachment device is comprised of a plurality of hooks which attaches the housing to the hood device.

6. A method comprising
placing a baffle, comprised of a housing, in a hood device;
attaching the baffle to the hood device, so that smoke sucked in by a fan in the hood device can pass through the baffle and into the hood device while the baffle remains stationary;
wherein the hood device lies over a cooking device;
and wherein the baffle is comprised of
a first set of a plurality of rails oriented in a first direction;
a second set of a plurality of rails oriented in a second direction which is opposite to the first direction;
wherein each of the first set of a plurality of rails overlaps one of each of the second set of a plurality of rails; and
wherein each of the rails of the first set and the second set of a plurality of rails is connected to a housing.

7. The method of claim 6 further wherein
the baffle is comprised of a lightweight metal material.

8. The method of claim 6 wherein
the baffle is comprised of aluminum.

9. The method of claim 6 wherein
the baffle is comprised of plastic.

10. The method of claim 6 wherein
the attachment device is comprised of a plurality of hooks which attaches the housing to the hood device.
